(19) United States
(12) Patent Application Publication
(10) Pub. No.: US 2004/0257144 A1
(43) Pub. Date: Dec. 23, 2004

(54) Variable resistance circuit

(75) Inventor: Mitsuru Nagata, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/814,346

(22) Filed: Apr. 1, 2004

(30) Foreign Application Priority Data
May 30, 2003 (JP) 2003-155022

(51) Int. Cl. H02M 5/42

(52) U.S. Cl. 327/343

(57) ABSTRACT

According to the present invention, there is provided a variable resistance circuit comprising,

a resistor unit having a plurality of resistors series-connected between an input terminal and a predetermined potential terminal, and a switch group including a plurality of switches each having one end connected to a node between the input terminal and the resistor, a node between the resistors, or a node between the resistor and the predetermined potential terminal, and the other end connected to an output terminal; and

a switch control circuit which supplies a control signal to the switch group,

wherein an attenuation step is generated by supplying the control signal to a pair of adjacent switches included in the switch group so as to complementarily, periodically turning on/off the pair of switches at a duty of a/b (a and b are positive integers which satisfy a<b) for one switch and a duty of (b−a)/b for the other switch.

### CROSS REFERENCE TO RELATED APPLICATION

This application is based upon and claims benefit of priority under 35 USC §119 from the Japanese Patent Application No. 2003-155022, filed on May 30, 2003, the entire contents of which are incorporated herein by reference.

### BACKGROUND OF THE INVENTION

The present invention relates to a variable resistance circuit which is suitably used for an audio amplifier or the like.

FIG. 30 shows an arrangement example in which a variable resistance circuit including a resistor 1101 and decoder 1100 is applied to an IC volume system. The IC does not allow formation of any large-capacity capacitor, and thus an amplifier 1001 and the variable resistance circuit are often DC-direct-coupled.

A switching control signal is input from the decoder 1100 to the resistor 1101 to turn on/off the switch, setting a desired attenuation amount. An output from the amplifier 1001 is input to an input terminal IN of the resistor 1101, and attenuated to a desired attenuation amount. An output from an output terminal OUT is input to a voltage follower circuit formed by a buffer 1004, and then output from it.

The resistor 1101 receives an input signal from the amplifier 1001 at one input terminal IN, and a voltage VDD/2 generated by resistors 1006 and 1007 and a buffer 1005 at a ground terminal REF.

In the circuit, a signal output from the amplifier 1001 swings by using the voltage VDD/2 as a center, and the ground terminal REF of the resistor 1101 is also grounded to the voltage VDD/2. No DC potential should be generated between the input terminal IN and ground terminal REF of the resistor 1101.

In practice, the amplifier 1001 and buffer 1005 have offset voltages Vos1 and Vos2. For this reason, a DC potential Vos1-Vos2 is generated across the resistor 1101. This value is a statistic that varies, and may reach several ten mV in the worst case.

This offset voltage may generate a click sound of several mV upon attenuation from 0 dB to −1 dB in the volume system of FIG. 30.

The click sound caused by the offset voltage also occurs in silence, and even a click sound of several mV is undesirable.

To prevent this, a large-capacity coupling capacitor may be externally connected between the amplifier 1001 and the resistor 1101. However, such capacitor is expensive, and the IC requires an extra external terminal. The volume occupied by the capacitor itself is large, posing problems in the entire design of an audio apparatus and the like.

To solve these problems, the number of attenuation steps in the variable resistance circuit may be increased. In this case, however, the resistance value of each resistor decreases, the precision must be increased, and the occupied area consequently becomes larger.

It is also difficult to increase the number of attenuation steps by increasing the number of resistors due to serious side effects such as variations in parasitic resistance and nonlinear distortion at the contact between each resistor and a wiring line.

References which disclose conventional variable resistance circuits are as follows:

Japanese Patent Laid-Open No. 2002-26670 Japanese Patent Laid-Open No. 2001-36361

As described above, it has conventionally been difficult to suppress a click sound generated upon changing the attenuation amount.

### SUMMARY OF THE INVENTION

According to one aspect of the present invention, there is provided a variable resistance circuit comprising:

a resistor unit having a plurality of resistors series-connected between an input terminal and a predetermined potential terminal, and a switch group including a plurality of switches each having one end connected to a node between the input terminal and the resistor, a node between the resistors, or a node between the resistor and the predetermined potential terminal, and the other end connected to an output terminal; and

a switch control circuit which supplies a control signal to the switch group,

wherein an attenuation step is generated by supplying the control signal to a pair of adjacent switches included in the switch group so as to complementarily, periodically turning on/off the pair of switches at a duty of a/b (a and b are positive integers which satisfy a<b) for one switch and a duty of (b−a)/b for the other switch.

According to one aspect of the present invention, there is provided a variable resistance circuit comprising:

a resistor unit having

first, second, . . . , (n-1)th (n is an integer of not less than 3) resistors which are series-connected between an input terminal and a predetermined potential terminal, and

first, second, . . . , nth switches each having one end connected to a node between the input terminal and one end of the first resistor, a node between the other end of the first resistor and one end of the second resistor, . . . , a node between the other end of the (n-2)th resistor and one end of the (n-1)th resistor, or a node between the other end of the (n-1)th resistor and the predetermined potential terminal, and the other end connected to an output terminal; and

a switching control circuit which generates a switching control signal for controlling ON/OFF states of the first, second, . . . , nth switches and supplies the switching control signal to the first, second, . . . , nth switches,

wherein in addition to n attenuation steps obtained by turning on any one of the first, second, . . . , (n-1)th switches, said switching control circuit generates m (m is a positive integer) additional attenuation steps by supplying, to the first, second, . . . , and nth switches, the switching control signal for complementarily, periodically turning on/off one switch at a duty of a/b (a and b are positive integers which satisfy a<b) and the other switch at a duty of (b−a)/b out of each of pairs of the first and second adjacent switches, the second and third adjacent switches, . . . , the (n-1)th and nth adjacent switches, and obtaining an attenuation amount calculated by internally dividing an attenuation amount x upon turning on only said one switch and an attenuation amount y upon turning on only said other switch at a:(b−a).

According to one aspect of the present invention, there is provided a variable resistance circuit comprising:

a resistor unit having

1ath, 2ath, . . . , (n-1)ath resistors which are series-connected between an input terminal and a predetermined potential terminal,

a 1bth resistor having one end connected to a node between the input terminal and one end of the 1ath resistor, a 2bth resistor having one end connected to a node between the other end of the lath resistor and one end of the 2ath resistor, . . . , a kbth resistor having one end connected to the other end of the (k−1)ath (k is a positive integer which satisfies k<n-1) resistor and one end of the ka resistor, and

first, second, . . . , nth switches each having one end connected to the other end of the 1bth resistor, the other end of the 2bth resistor, . . . , the other end of the kbth resistor, a node between the other end of the kath resistor and one end of the (k+1)ath resistor, . . . , or a node between the other end of the (n-1)ath resistor and the predetermined potential terminal, and the other end connected to an output terminal; and

a switching control circuit which generates a switching control signal for controlling ON/OFF states of the first, second, . . . , nth switches and supplies the switching control signal to the first, second, . . . , nth switches,

wherein letting x be an attenuation amount upon turning on only one switch and y be an attenuation amount upon turning on only the other switch out of each of pairs of the first and second adjacent switches, the second and third adjacent switches, . . . , the (k−1)th and kth adjacent switches, said switching control circuit supplies the switching control signal to the first, second, . . . , nth switches so as to simultaneously turn on said one switch and said other switch, while turning on said one switch, periodically turn on/off said other switch at a duty of a/b, or periodically turn on/off said one switch at a duty of a/b and turn on said other switch in order to obtain an intermediate attenuation amount between x and y,

letting x be the attenuation amount upon turning on only said one switch and y be the attenuation amount upon turning on only said other switch, resistance values of the 1bth, 2bth, . . . , kbth resistors are so set as to adjust the attenuation amount to (x+y)/2 when said one switch and said other switch are simultaneously turned on, and

an attenuation amount calculated by internally dividing the attenuation amount x and an attenuation amount (x+y)/2 at a:(b−a) is generated by turning on said one switch and periodically turning on/off said other switch at a duty of a/b, and an attenuation amount calculated by internally dividing the attenuation amount (x+y)/2 and the attenuation amount y at (b−a) : a is generated by periodically turning on/off said one switch at the duty of a/b and turning on said other switch.

### BRIEF DESCRIPTION OF THE DRAWINGS

FIG. 1 is a block diagram showing the arrangement of a variable resistance circuit according to the first and second embodiments of the present invention;

FIG. 2 is a circuit diagram showing the arrangement of a resistor unit included in the variable resistance circuit;

FIG. 3 is an explanatory view showing the sign of a switch included in the variable resistance circuit;

FIG. 4 is a circuit diagram showing the detailed arrangement of the switch included in the variable resistance circuit;

FIG. 5 is a flow chart showing the operation of a decoder 102 included in the variable resistance circuit;

FIG. 6 is a table showing the correspondence between the input and output signals of the decoder 102;

FIG. 7 is a logic diagram showing the arrangement of a comparator 103 included in the variable resistance circuit;

FIG. 8 is a logic diagram showing the arrangement of an up/down counter 104 included in the variable resistance circuit;

FIG. 9 is a logic diagram showing the arrangement of a decoder 105 included in the variable resistance circuit;

FIG. 10 is a timing chart showing the waveform of a switching control signal used to generate two attenuation steps in the variable resistance circuit;

FIG. 11 is a timing chart showing the waveform of a switching control signal used to generate three attenuation steps in the variable resistance circuit;

FIG. 12 is a timing chart showing the waveform of a switching control signal used to generate four attenuation steps in the variable resistance circuit;

FIG. 13 is a timing chart showing the waveform of a switching control signal input to the resistor unit of the variable resistance circuit according to the first embodiment of the present invention;

FIG. 14 is a timing chart showing the waveform of the switching control signal input to the resistor unit of the variable resistance circuit;

FIG. 15 is a logic diagram showing the arrangement of a decoder 106 included in the variable resistance circuit;

FIG. 16 is a circuit diagram showing the arrangement of a resistor unit included in the variable resistance circuit according to the second embodiment of the present invention;

FIG. 17 is a timing chart showing the waveform of a switching control signal input to the resistor unit of the variable resistance circuit;

FIG. 18 is a timing chart showing the waveform of the switching control signal input to the resistor unit of the variable resistance circuit;

FIG. 19 is a logic diagram showing the arrangement of a decoder 106 included in the variable resistance circuit;

FIG. 20 is an explanatory view showing calculation of Δ-Y conversion in the variable resistance circuit;

FIG. 21 is an explanatory view showing calculation of Δ-Y conversion in the variable resistance circuit;

FIG. 22 is a circuit diagram showing potentials at the nodes of a plurality of resistors series-connected between the input terminal and the ground terminal in the variable resistance circuit;

FIG. 23 is a circuit diagram showing potentials at nodes at which resistors are series-connected to the nodes of a plurality of resistors series-connected between the input terminal and the ground terminal in the variable resistance circuit;

FIG. 24 is a circuit diagram for explaining the potentials at the nodes shown in FIG. 23;

FIG. 25 is a timing chart showing the waveform of another switching control signal used in the variable resistance circuit according to the second embodiment of the present invention;

FIG. 26 is a timing chart showing the waveform of the switching control signal used in the variable resistance circuit;

FIG. 27 is a timing chart showing the waveform of the switching control signal used in the variable resistance circuit;

FIG. 28 is a circuit diagram showing an example of the arrangement of a resistor unit subjected to switching control as another embodiment of the present invention;

FIG. 29 is a circuit diagram showing an example of the arrangement of a resistor unit subjected to switching control as still another embodiment of the present invention; and

FIG. 30 is a circuit diagram showing the arrangement of a volume system using a conventional variable resistance circuit.

### DESCRIPTION OF THE EMBODIMENTS

Embodiments of the present invention will be described with reference to the accompanying drawings.

(1) First Embodiment

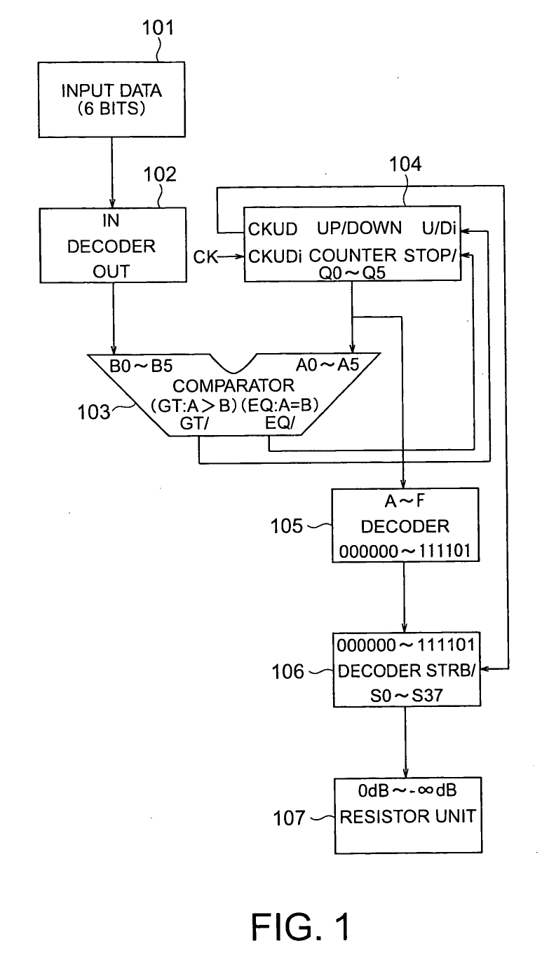

FIG. 1 shows the arrangement of a variable resistance circuit according to the first embodiment. The variable resistance circuit comprises a switching control circuit and a resistor unit 107. The switching control circuit has decoders 105 and 106 and a conversion circuit including a decoder 102, comparator 103, and up/down counter 104.

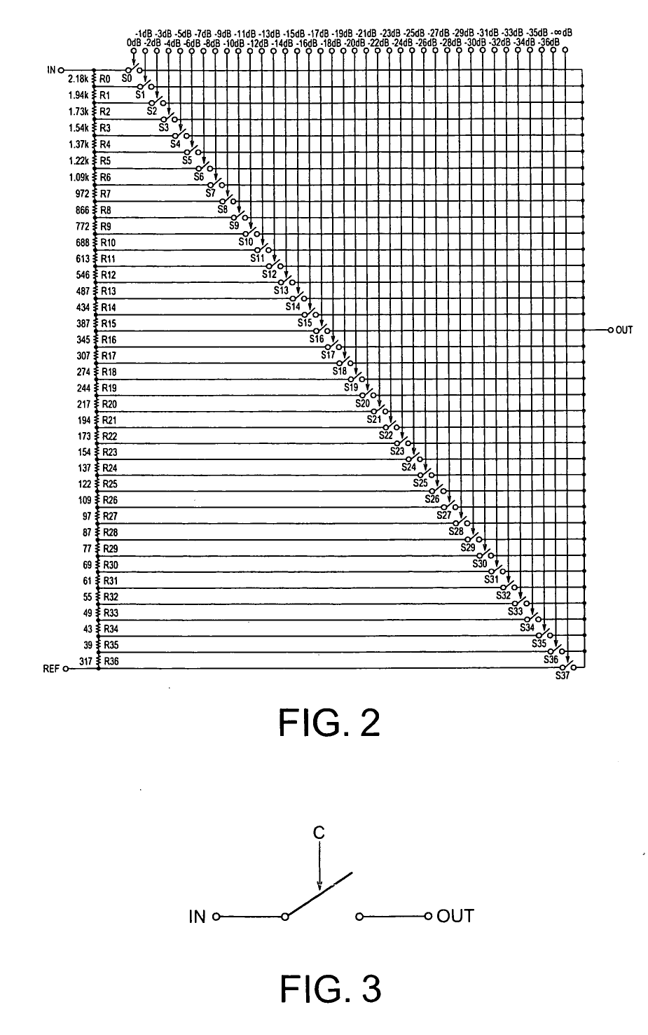

FIG. 2 shows an arrangement example of the resistor unit which is included in the variable resistance circuit and comprises a resistor group and analog switch group.

The resistor group comprises resistors R0 to R36 which are series-connected between an input terminal IN and a ground voltage terminal REF. The analog switch group comprises a plurality of analog switches S0 to S37 each having one end connected to one of the input terminal IN, the node (tap) of each resistor, or the ground voltage terminal REF, and the other end connected to an output terminal OUT.

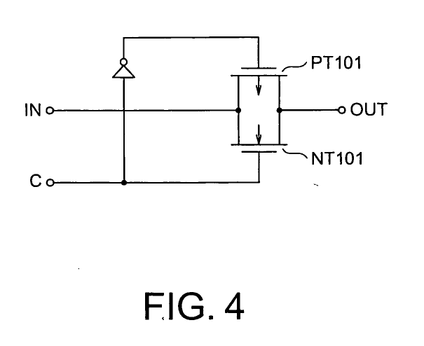

The analog switches S0 to S37 are equivalent to an analog switch S shown in FIG. 3. More specifically, as shown in FIG. 4, the analog switch S comprises a P-channel transistor PT101 and N-channel transistor NT101 whose ON/OFF-states are controlled by a control signal input from a control terminal C.

Input data 101 contains signals which are equal in number to switches included in the resistor unit 107. The conversion circuit including the decoder 102, comparator 103, and up/down counter 104 converts the input data 101 into signals corresponding to the number of attenuation steps larger than the number of switches. The decoders 105 and 106 receive these signals, generate switching control signals for turning on/off each switch at a duty (to be described later), and supply the signals to the switches.

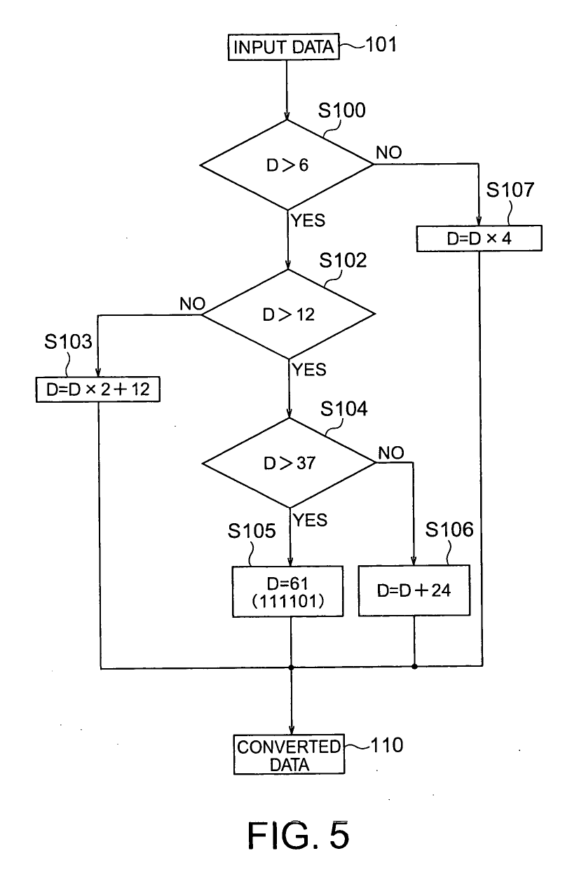

The input data 101 is first input to the decoder 102, which outputs the decoded signal. The contents of processing in the decoder 102 are shown in the flow chart of FIG. 5.

The decoder 102 receives 6-bit (A to F) input data 101, and the input data 101 has 38 steps in correspondence with the switches S0 to S37.

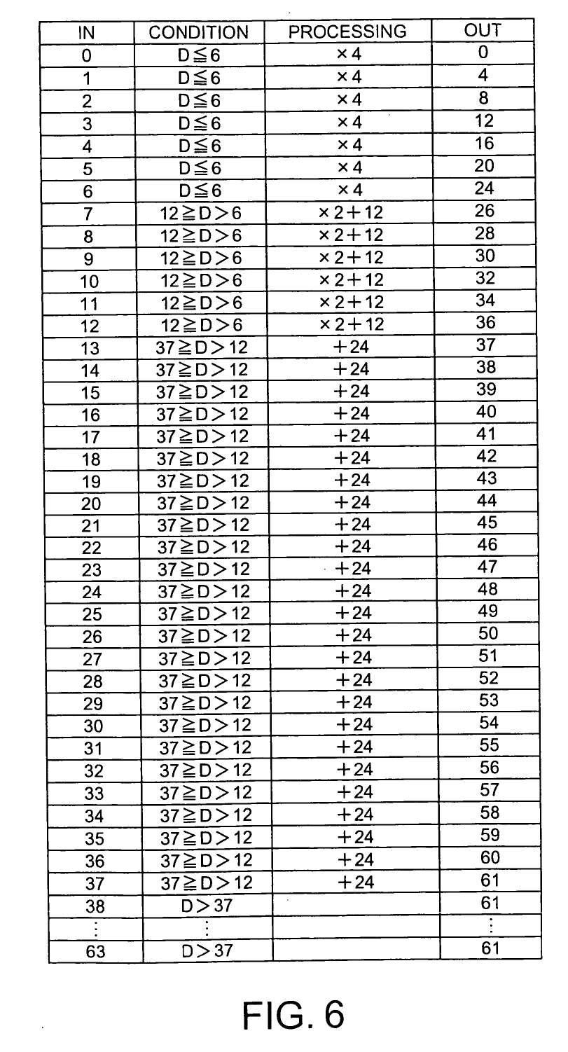

Upon reception of the input data 101, the decoder 102 converts the input data 101 into data 110 having a larger number of steps, i.e., 61 steps. FIG. 6 shows the correspondence used to convert the input data 101 having 38 steps into the data 110 having 61 steps, conditions for performing conversion processing, and processing contents. The input data 101 must have at least 38 steps in correspondence with the switches S0 to S37, but may have 39 or more steps, as shown in FIG. 6. Even if the input data 101 has 39 or more signals, the converted data 110 has the same value (61) as the 38th input signal after conversion processing.

For example, when the input data 101 is “6 (decimal notation)”, a condition “D≦6” is satisfied. In this case, processing “×4” is performed to obtain converted data 110 “24”.

Similarly, when the input data 101 is “18”, a condition “37≧D>12” is satisfied. In this case, processing “+24” is performed to obtain converted data 110 “42”.

This sequence corresponds to processing shown in the flow chart of FIG. 5.

More specifically, whether the input data D is larger than 6 is determined in step S100. If the input data D is equal to or smaller than 6, the flow shifts to step S107 to multiply the input data D by 4 and output the product as the converted data 110. If the input data D is larger than 6, the flow shifts to step S102.

In step S102, whether the input data D is larger than 12 is determined. If the input data D is equal to or smaller than 12, the input data D is multiplied by 2, and 12 is added to the product in step S103. The sum is output as the converted data 110. If the input data D is larger than 12, the flow shifts to step S104.

In step S104, whether the input data D is larger than 37 is determined. If the input data D is equal to or smaller than 37, 24 is added to the input data D in step S106, and the sum is output as the converted data 110. If the input data D is larger than 37, the input data D is fixed to 61 in step S105, and output as the converted data 110.

The output converted data 110 includes input signals B0 to B5 to the comparator 103. The comparator 103 receives the input signals B0 to B5, also receives signals A0 to A5 output from the up/down counter 104, and compares these signals. “0” is output from a terminal GT/ for A>B, and “1” is output from the terminal GT/ for A<B until A=B.

The up/down counter 104 receives these outputs, and keeps counting without receiving any stop signal “0” at a terminal STOP/ until A=B.

For A>B, a signal “0” for performing down counting of sequentially decreasing A is input to a terminal U/Di. For A<B, a signal “1” for performing up counting of sequentially increasing A is input to the terminal U/Di.

The signals A0 to A5 which come close to the input signals B0 to B5 by each attenuation step are output to the decoder 105 until the signals A0 to A5 coincide with the input signals B0 to B5.

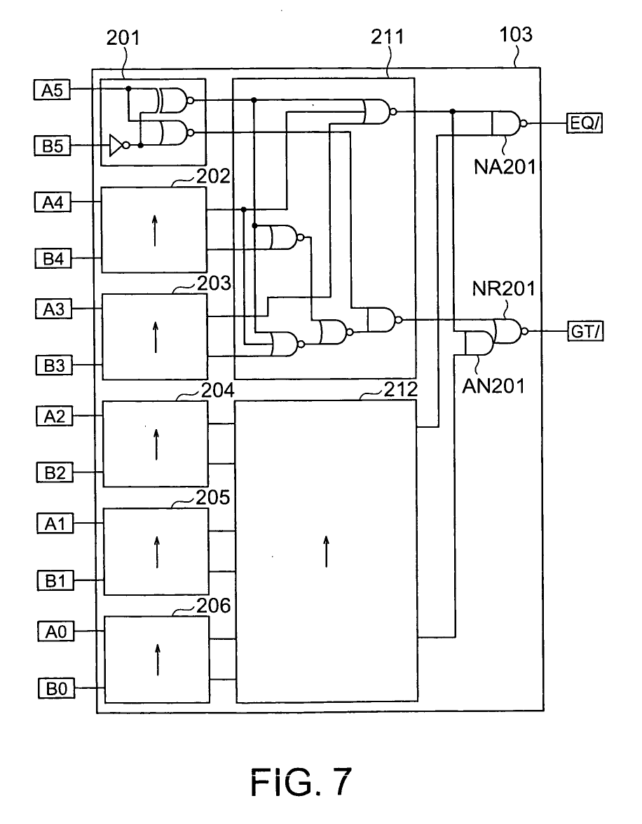

The comparator 103 has a detailed arrangement as shown in FIG. 7. The signals A0 and B0, A1 and B1, . . . , A5 and B5 to be compared are input to corresponding circuit blocks 201 to 206. Outputs from the circuit blocks 201 to 206 are processed by circuit blocks 211 and 212. Outputs from the circuit blocks 211 and 212 are supplied to a NAND circuit NA201 to generate a signal EQ/ representing coincidence/noncoincidence, or to an AND circuit AN201 and NOR circuit NR201 to generate a signal GT/ representing whether A>B.

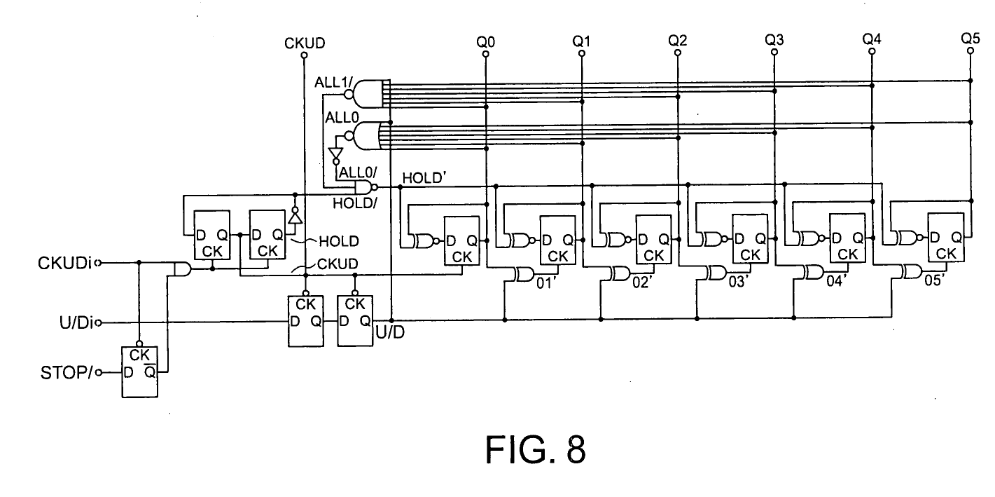

The up/down counter 104 has an arrangement as shown in FIG. 8. The up/down counter 104 receieves a clock at its terminal CKUDi, the signal EQ/ at its terminal STOP/, and the signal GT/ at its terminal U/Di. The up/down counter 104 generates data Q0 to Q5, and outputs them to the decoder 105.

The signals Q0 to Q5 output from the up/down counter 104 are input as signals A to F to the decoder 105 on the first stage, and decoded to output signals “000000” to “111101”. These signals are input to the decoder 106 on the second stage, and decoded to generate switching control signals S0 to S37. The switching control signals S0 to S37 are output to the resistor unit 107. The ON/OFF states of the switches S0 to S37 in the resistor unit 107 are controlled at a predetermined duty, realizing a desired number of attenuation steps.

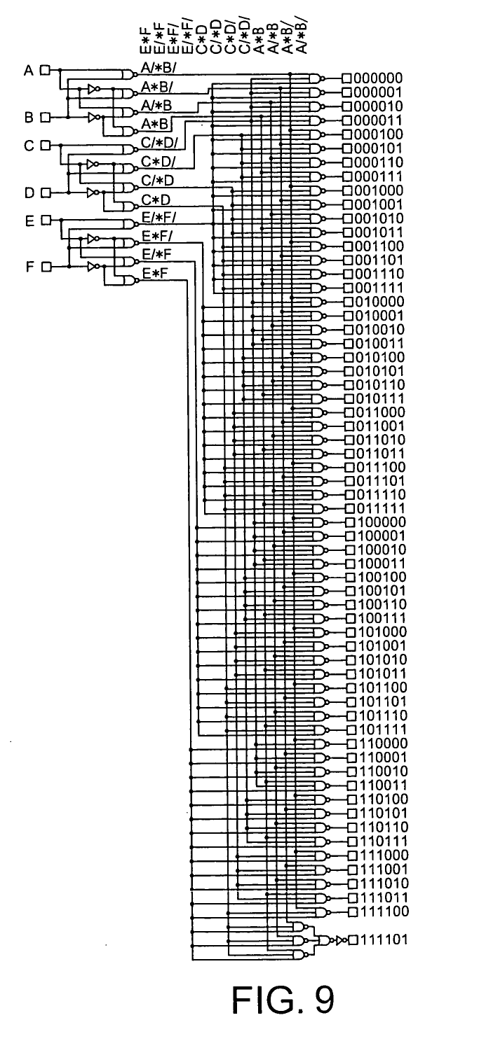

FIG. 9 shows an example of the detailed circuit arrangement of the decoder 105. The decoder 105 receives the output signals Q0 to Q5 from the up/down counter 104 at its terminals A to F, and outputs decoding results as “000000” to “111101”. The decoder 106 has an arrangement which is different between embodiments (to be described later).

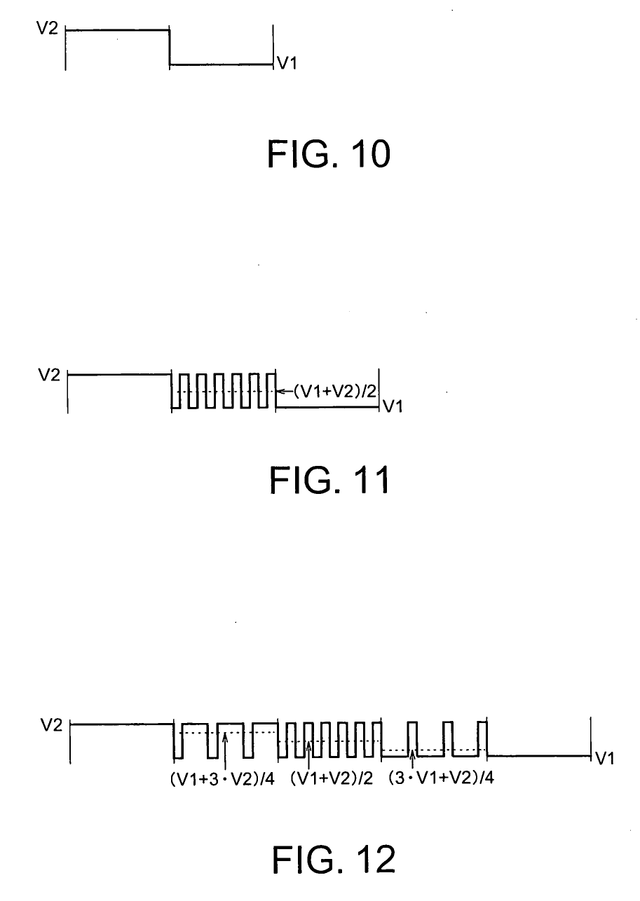

The principle of realizing a larger number of attenuation steps using input signals equal in number to switches according to the first embodiment will be explained with reference to FIGS. 10 to 12.

In the circuit of FIG. 3, a DC potential is applied to the input IN to complementarily turn on/off two adjacent switches. Two levels of voltages V2 and V1 are obtained at the output OUT, as shown in FIG. 10.

When two adjacent switches are complementarily turned on/off at a duty of 1/2, a new level of a voltage (V1+V2)/2 can be generated, obtaining three levels of the voltages V2, (V1+V2)/2, and V1, as shown in FIG. 11.

When the duty is set to 3/4, 1/2, and 1/4, three new levels of voltages (V1+3*V2)/4, (V1+V2)/2, and (3*V1+V2)/4 can be obtained, as shown in FIG. 12. Accordingly, five levels of the voltages V2, (V1+3*V2)/4, (V1+V2)/2, and (3*V1+V2)/4, and V1 can be attained.

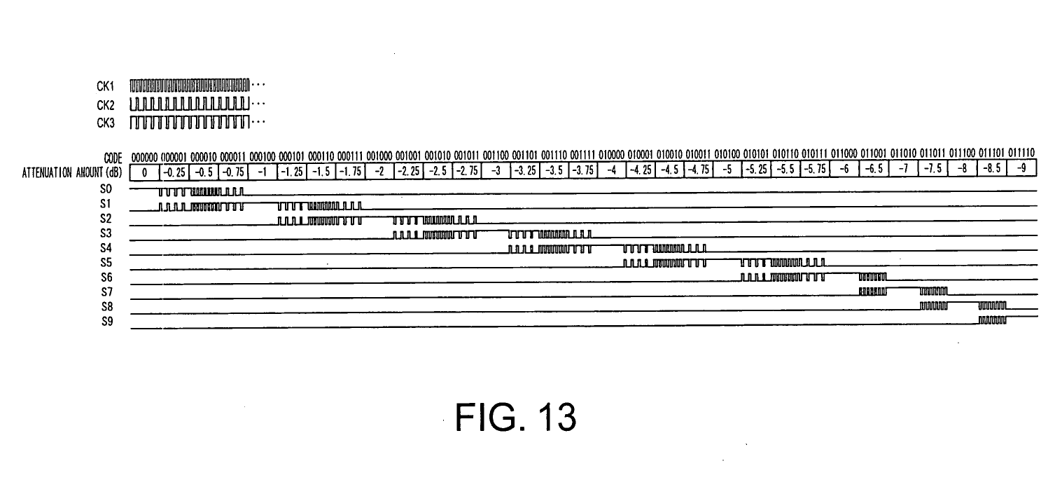

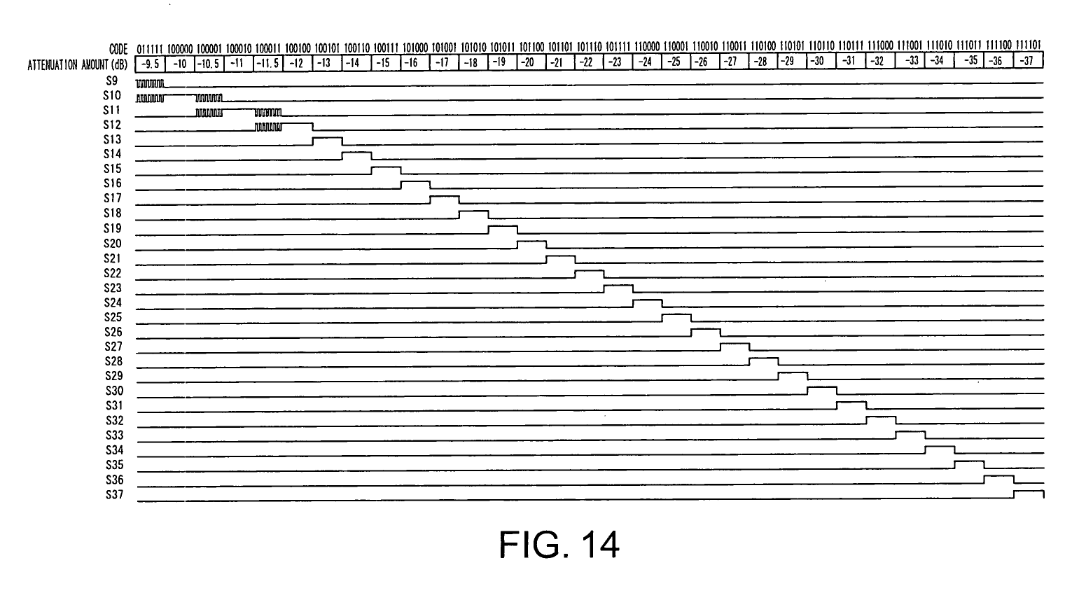

FIGS. 13 and 14 show the ON/OFF timing charts of the switching elements S0 to S37 in the first embodiment.

The first embodiment employs three clocks CK1, CK2, and CK3 as clocks used to generate a switching control signal. The duty is 1/2 for the clock CK1, 1/4 for the clock CK2, and 3/4 for the clock CK3.

In the first embodiment, in order to generate −0.5 dB between 0 dB and −1 dB, the switch S0 which generates 0 dB and the switch S1 which generates −1 dB are periodically switched at high speed with a duty of 1/2 complementarily (when one switch is ON, the other is OFF). Switching at a high speed of, e.g., 20 kHz or more can suppress a click sound because this sound is sensed as an attenuation amount of about 0.5 dB by the ear. That is, the cycle in which the two switches S0 and S1 are turned on/off is desirably smaller than the reciprocal of the audio frequency. In this cycle, the frequency of a ripple component in switching the attenuation amount exceeds the audio frequency band, and generation of an uncomfortable beat sound can be prevented.

By the same principle, the switch S0 which generates 0 dB is switched at a duty of 3/4, and the switch S1 which generates −1 dB is alternately switched at a duty of 1/4, generating −0.25 dB.

Similarly, the switch S0 which generates 0 dB is switched at a duty of 1/4, and the switch S1 which generates −1 dB is alternately switched at a duty of 3/4, generating −0.75 dB.

In this fashion, of a switch Sx which generates −x (x is an arbitrary integer within the range of 0 to 37) dB and an adjacent switch S(x+1) which generates −(x+1) dB, the switch Sx for −x dB is ON/OFF-controlled at a duty of a/b. The switch S(x+1) for −(x+1) dB is complementarily, periodically ON/OFF-controlled at a duty of (b−a)/b. An attenuation amount obtained by internally dividing the attenuation amounts of −x dB and −(x+1) dB at a:b can be attained.

The first embodiment adopts a duty interval of 1/4, but the attenuation step width can be more finely set by setting a larger duty (e.g., 1/8, 1/16, . . . ).

As the ON/OFF time becomes shorter, switching operation cannot follow due to the limitation on the ON/OFF speeds of the switches S0 to S37. The duty must be set in consideration of the switching response characteristic.

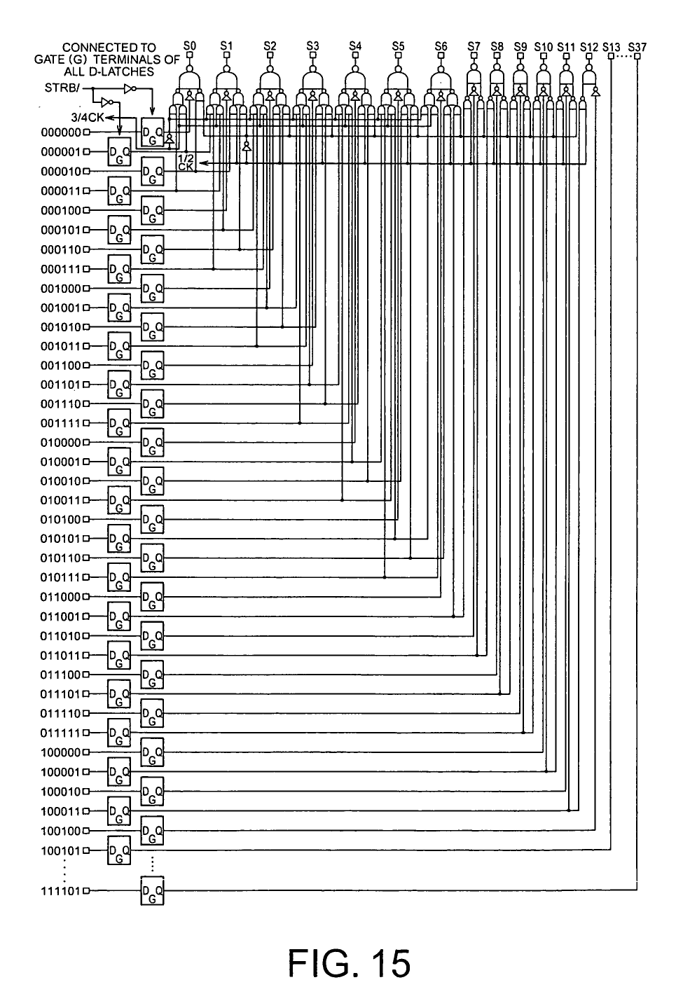

FIG. 15 shows an example of the detailed arrangement of the decoder 106 which generates the switching control signals S0 to S37.

As described with reference to FIG. 1, the signals “000000” to “111101” are output from the decoder 105 on the first state, and input to the decoder 106. The decoder 106 comprises a logical arrangement as shown in FIG. 15, and generates and outputs the switching control signals S0 to S37 having waveforms shown in FIGS. 13 and 14.

According to the first embodiment, attenuation steps larger in number than switches can be realized by controlling the ON/OFF duties of the switches S0 to S37 while minimizing an increase in circuit scale. The attenuation step width can be further decreased, and the attenuation amount can be changed more smoothly, reducing a click sound.

The duty may also be so controlled as to decrease the attenuation step width for ON/OFF operation of all the switches S0 to S37. However, the circuit which generates a switching control signal can be downsized by applying duty control to only a portion having a relatively large attenuation step width, as shown in FIGS. 13 and 14.

(2) Second Embodiment

A variable resistance circuit according to the second embodiment of the present invention will be explained.

Similar to the first embodiment, the second embodiment comprises the same arrangement shown in FIG. 1 except for the circuit arrangements of a decoder 106 and resistor unit 107.

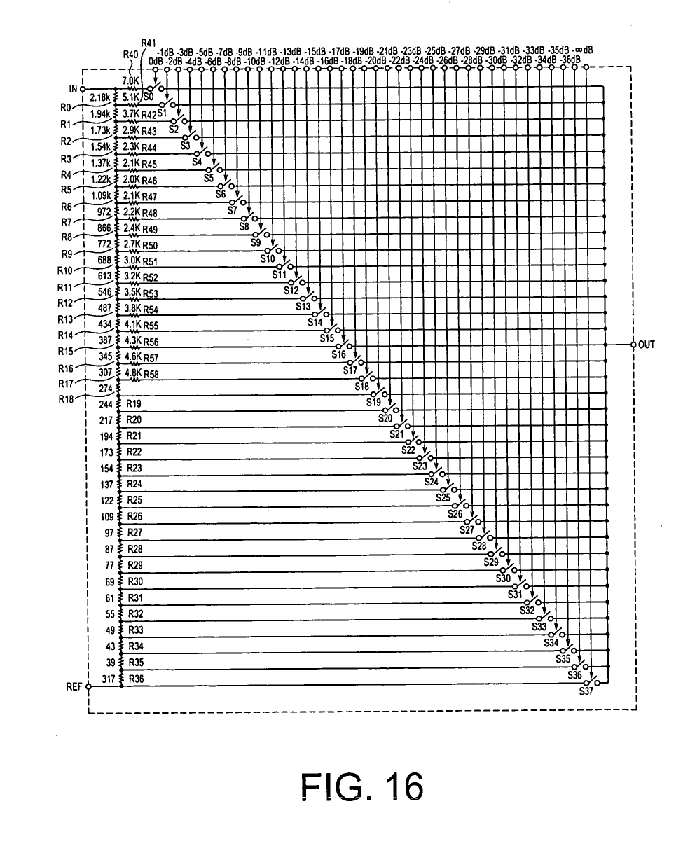

FIG. 16 shows the arrangement of the resistor unit according to the second embodiment. In the resistor unit according to the second embodiment, compared to the resistor unit shown in FIG. 2 according to the first embodiment, resistors R40 to R58 are further series-connected between switches S0 to S37, and the nodes between the input terminal IN and resistors.

For example, the resistor R40 is connected between the input terminal IN and the switch S0, the resistor R41 is connected between the switch S1 and the node between resistors R0 and R1, the resistor R42 is connected between the switch S2 and the node between resistors R1 and R2, . . . , and the resistor R58 is connected between the switch S18 and the node between resistors R17 and R18.

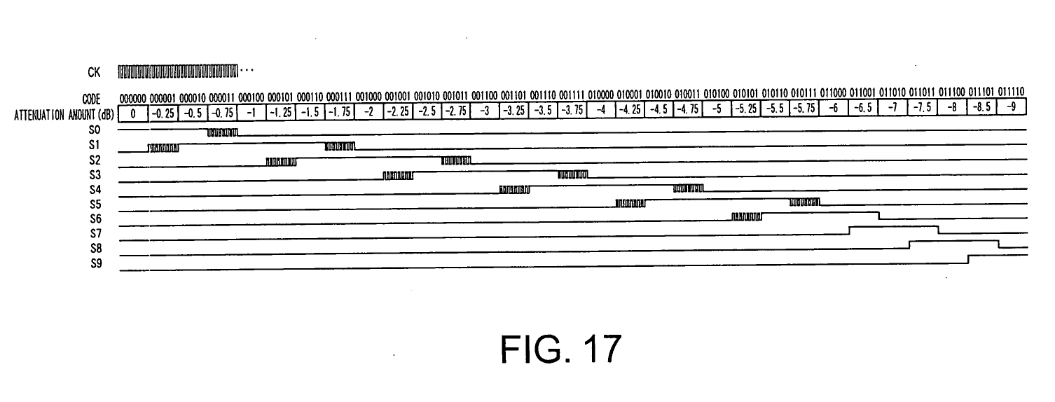

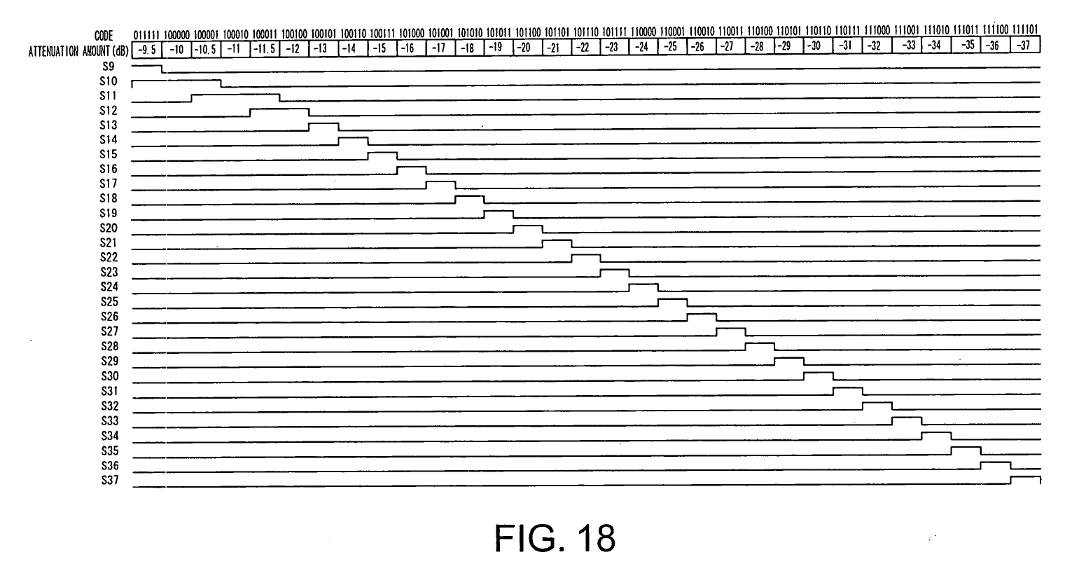

FIGS. 17 and 18 show the timing charts of switching control signals S0 to S37 which control ON/OFF operation of the switches S0 to S37 in the resistor unit having the above arrangement.

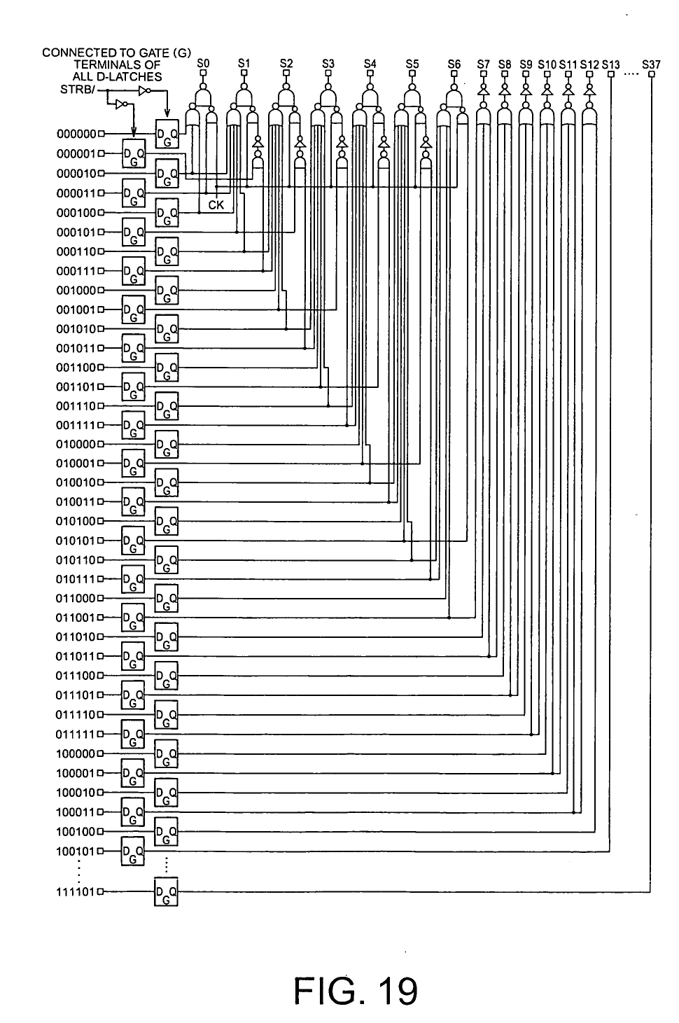

FIG. 19 shows an example of the detailed circuit arrangement of the decoder 106 on the second stage which generates the switching control signals S0 to S37 having these waveforms.

The second embodiment adopts one clock CK, unlike the first embodiment. The clock CK has a duty of 1/2. In comparison with the first embodiment, the second embodiment further adds the resistors R40 to R58 to the resistor unit. Attenuation steps equal in number to those in the first embodiment are realized using only one clock CK.

For example, in order to generate an attenuation amount of −0.5 dB between attenuation amounts 0 dB and −1 dB, both the switch S0 which generates 0 dB and the switch S1 which generates −1 dB are turned on.

The resistors R40, R0, and R41 between the switches S0 and S1 are series-connected, and the node between the resistors R40 and R41 is connected to the output terminal OUT. By properly determining the values of the resistors R40 and R41, −0.5 dB can be generated.

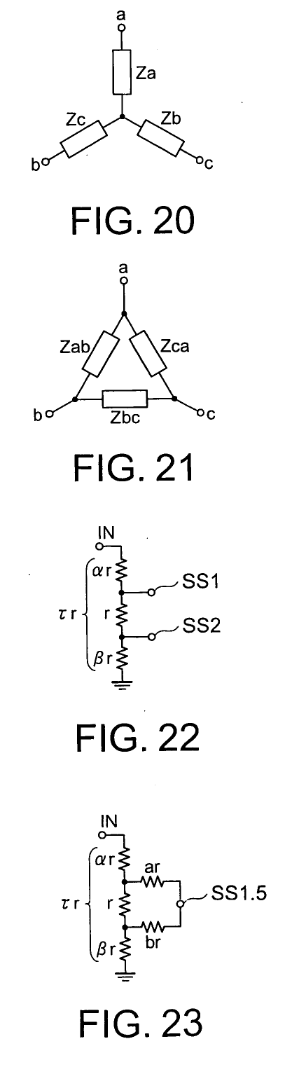

A method of setting a resistance value will be explained with reference to FIGS. 20 to 24.

When impedances Za, Zb, and Zc are Y-connected, as shown in FIG. 20, and impedances Zab, Zbc, and Zca are delta-connected, as shown in FIG. 21, these connections satisfy

Za=Zab·Zca/(Zab+Zbc+Zca) (1)

Zb=Zbc·Zab/(Zab+Zbc+Zca) (2)

Zc=Zca·Zbc/(Zab+Zbc+Zca) (3)

Zab=(Za·Zb+Zb·Zc+Zc·Za)/Zc (4)

Zbc=(Za·Zb+Zb·Zc+Zc·Za)/Za (5)

Zca=(Za·Zb+Zb·Zc+Zc·Za)/Zb (6)

On the basis of this relationship, two adjacent attenuation steps in the arrangement shown in FIG. 22 will be examined.

Resistors αr, r, and βr are series-connected between the input terminal IN and the ground terminal REF. Attenuation steps at a node SS1 between the resistors αr and r and a node SS2 between the resistors r and βr are calculated.

A resistance division ratio RSS1 at the node SS1 is given by

$$\begin{matrix}RSS 1 = ( r + β r ) / ( α r + r + β r ) \\ = ( β + 1 ) / ( α + β + 1 ) \\ = ( β + 1 ) / τ where \\ τ = α + β + 1\end{matrix} \qquad ( 7 )$$

A resistance division ratio RSS2 at the node SS2 is given by

$$\begin{matrix}RSS 2 = β r / ( α r + r + β r ) \\ = β / ( α + β + 1 ) \\ = β / τ\end{matrix} \qquad ( 8 )$$

The arrangement of the resistor unit in the second embodiment is applied to the connection relationship shown in FIG. 22, thus obtaining an arrangement as shown in FIG. 23. That is, resistors ar and br are series-connected between the node SS1 between the resistors αr and r and the node SS2 between the resistors r and βr.

The relationship between the resistors ar and br are so set as to adjust a resistance division ratio RSS1.5 at a node SS1.5 between the resistors ar and br to

$$\begin{matrix}RSS 1.5 = ( β + 1 / 2 ) / ( α + β + 1 ) \\ = ( β + 1 / 2 ) / τ\end{matrix} \qquad ( 9 )$$

As a result, an intermediate attenuation step of 1.5 between an attenuation step of 1 at the node SS1 and an attenuation step of 2 at the node SS2 can be generated.

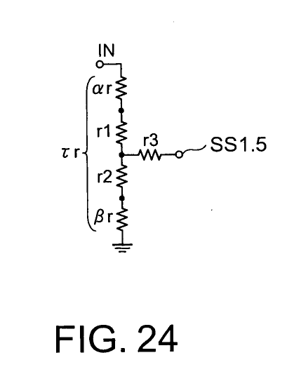

By applying Δ-Y conversion shown in FIGS. 20 and 21, resistors r1, r2, and r3 shown in FIG. 24 satisfy

r1=ar·r/(ar+br+r)=ar/(a+b+1) (10)

r2=br/(a+b+1) (11)

r3=abr/(a+b+1) (12)

The resistance division ratio RSS1.5 at the terminal SS1.5 connected to the resistor r3 is given by

$$\begin{matrix}RSS 1.5 = ( r2 + β r ) / ( α r + r 1 + r 2 + β r ) \\ = [ β + b / ( a + b + 1 ) ] / [ α + β + ( a + b ) / ( a + b + 1 ) ]\end{matrix} \qquad ( 13 )$$

Hence, the resistance value a of the resistor ar and the resistance value b of the resistor br are so set as to establish

$$( β + 1 / 2 ) / ( α + β + 1 ) = [ β + b / ( a + b + 1 ) ] / [ α + β + ( a + b ) / ( a + b + 1 ) ] \qquad ( 14 )$$

The resistance division ratio at the terminal SS1.5 can be adjusted to the intermediate value between the nodes SS1 and SS2.

This yields

a−b=(β−α)/(α+β+1)=(β−α)/π (15)

The resistance values of the resistors R40 to R58 shown in FIG. 16 are calculated according to the above method.

The switching control signals shown in FIGS. 17 and 18 switch the ON/OFF states of two adjacent switches at a duty of 1/2 by using the single clock CK having a duty of 1/2. For example, in order to generate −1/4 dB, the switch S0 which generates 0 dB is turned on, and the switch S1 which generates −1 dB is turned on/off at high speed with a duty of 1/2. Similarly, in order to generate −1/2 dB, the switches S0 and S1 are simultaneously turned on. In order to generate −3/4 dB, the switch S0 is turned on/off at high speed with a duty of 1/2, and the switch S1 is turned on.

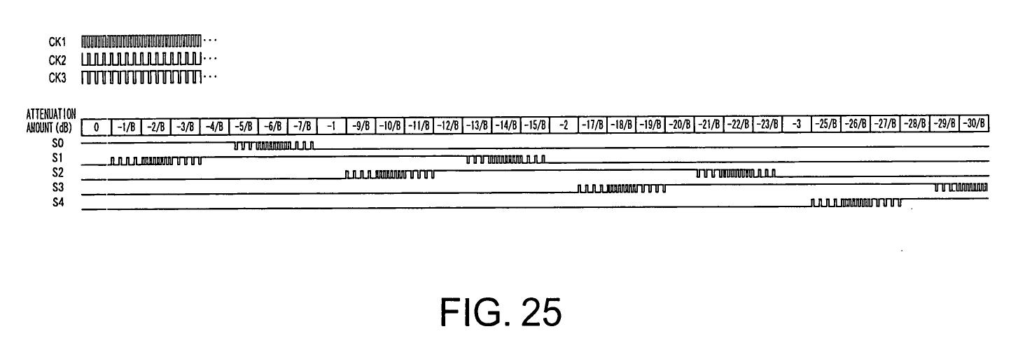

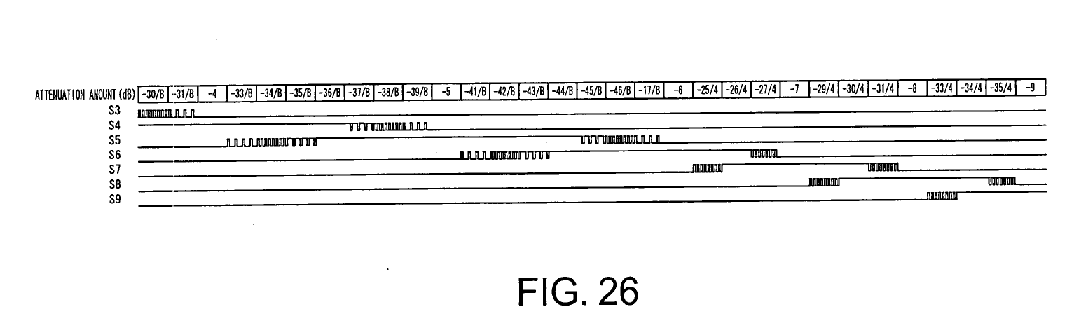

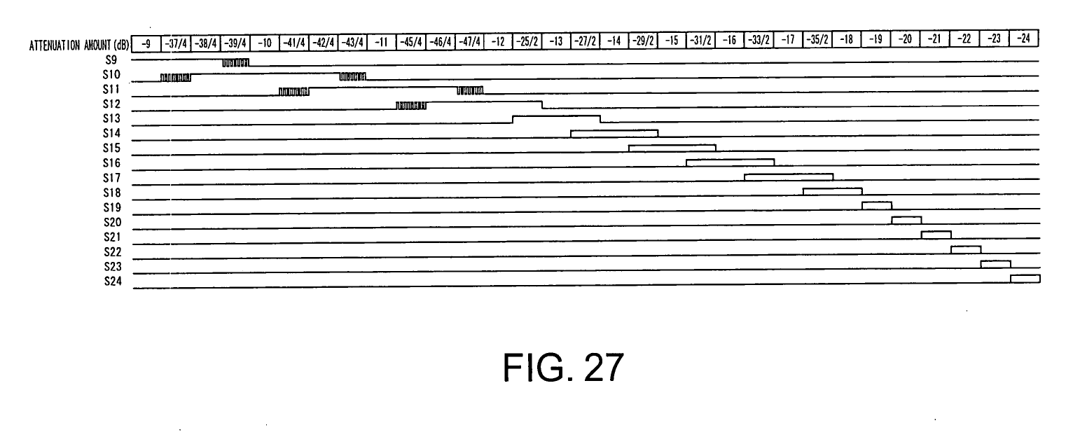

To the contrary, switching control signals shown in FIGS. 25, 26, and 27 are based on the three clocks CK1, CK2, and CK3, similar to the first embodiment. The clock CK1 has a duty of 1/2, the clock CK2 has a duty of 1/4, and the clock CK3 has a duty of 3/4.

A desired number of attenuation steps may also be realized using these clocks CK1 to CK3.

For example, in order to generate −1/8 dB, the switch S0 which generates 0 dB is turned on, and the switch S1 which generates −1 dB is switched at high speed with a duty of 1/4.

Similarly, in order to generate −2/8 dB, the switch S0 which generates 0 dB is turned on, and the switch S1 is switched with a duty of 1/2.

In order to generate −3/8 dB, the switch S0 which generates 0 dB is turned on, and the switch S1 which generates −1 dB is switched with a duty of 3/4.

Similarly, in order to generate −1/2 dB, both the switch S0 which generates 0 dB and the switch S1 which generates −1 dB are turned on.

According to the second embodiment, similar to the first embodiment, attenuation steps larger in number than switches are generated while suppressing an increase in circuit scale. The attenuation step width can be decreased, and the attenuation amount can be changed more smoothly, reducing a click sound.

In the resistor unit according to the second embodiment, as shown in FIG. 16, the resistors R40 to R58 are connected between the switches S0 to S18 and the nodes between the input terminal IN and the resistors R0 to R18. This can increase the number of attenuation steps. In addition, any operation error upon generation of an abnormally high voltage can be prevented even when two adjacent switches are turned on due to the difference between the waveforms of switching control signals which control the ON/OFF states of these switches. Also in the first embodiment, similar to the second embodiment, at least one resistor may be connected to a similar portion.

If the ON resistances of the switches S0 to S18 have non-negligible values for the resistors R40 to R58, values obtained by subtracting the ON resistance values of the switches S0 to S18 from the calculated resistance values of the resistors R40 to R58 may be set as the resistance values of the resistors R40 to R58. For example, when the ON resistance of the switch S0 is r0, a value obtained by subtracting r0 from the calculated value of the resistor R40 is set as the resistance value of the resistor R40.

Also in the second embodiment, similar to the first embodiment, the cycle in which two adjacent switches are complementarily turned on/off is desirably smaller than the reciprocal of the audio frequency. By setting this cycle, the frequency of a ripple component in switching the attenuation amount exceeds the audio frequency band, and generation of an uncomfortable beat sound can be prevented.

The above-described embodiments are merely examples, and do not limit the present invention.

For example, the arrangement shown in FIG. 1 comprises the decoder 102, comparator 103, up/down counter 104, decoders 105 and 106, and resistor unit 107 as a switching control circuit. However, the present invention is not limited to this arrangement, and can take another arrangement as far as two adjacent switches in the resistor unit 107 are turned on at a predetermined duty complementarily and periodically, or simultaneously, or one switch is turned on and the other switch is periodically turned on at a predetermined duty, thereby realizing an intermediate attenuation amount between two attenuation amounts upon turning on only one switch, and providing attenuation steps larger in number than switches in the resistor unit 107.

Similarly, the numbers of resistors and switches in the resistor unit can be arbitrarily set. The waveforms of switching control signals which control the ON/OFF states of switches are not limited to those in FIGS. 13, 14, 17, 18, 25, 26 and 27.

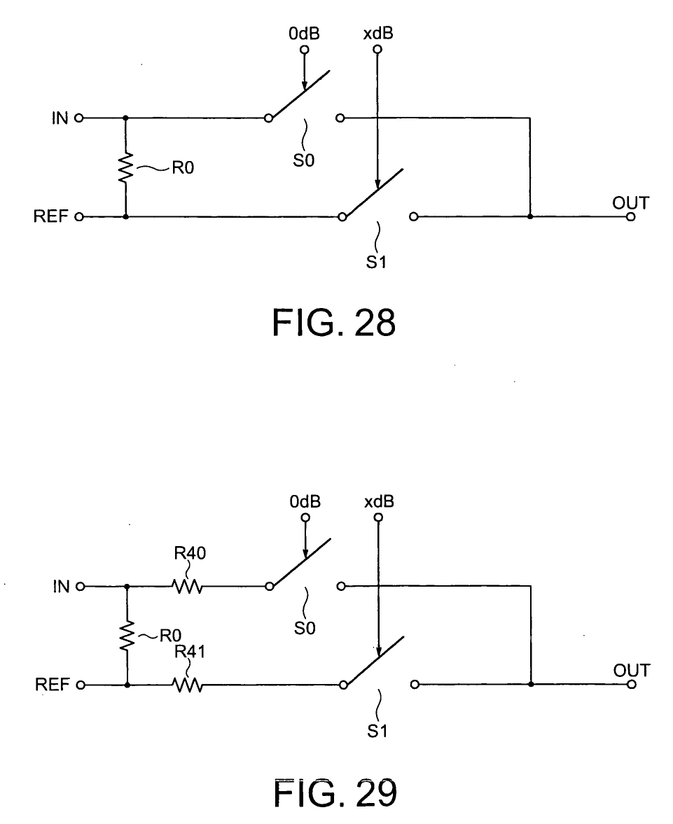

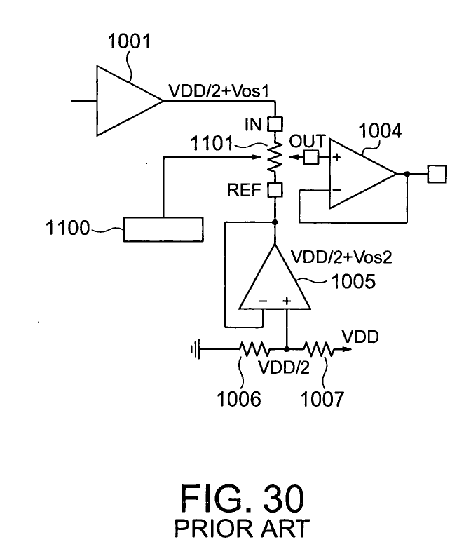

For example, as a minimum arrangement of the resistor unit subjected to switching control, one resistor R0 may be series-connected between the input terminal IN and the ground voltage terminal REF, the analog switch S0 may be connected between the input terminal IN and the output terminal OUT, and the analog switch S1 may be connected between the ground voltage terminal REF and the output terminal OUT, as shown in FIG. 28. The analog switches S0 and S1 are ON/OFF-controlled in the same manner as the first embodiment, thereby obtaining an attenuation step between an attenuation amount of 0 dB upon turning on only the analog switch S0 and an attenuation amount of x dB upon turning on only the analog switch S1.

As shown in FIG. 29, the present invention can also adopt both or one of the resistor R40 between one end of the resistor R0 and one end of the analog switch S0 and the resistor R41 between the other end of the resistor R0 and one end of the analog switch S1.

In the variable resistance circuit according to the above embodiments, an attenuation amount a is generated by turning on one of two adjacent switches in the resistor unit and turning off the other switch, and a attenuation amount b is generated by turning off one switch and turning on the other switch. In this case, an attenuation amount between the attenuation amounts a and b is realized by turning on these switches at a predetermined duty complementarily and periodically, or simultaneously, or turning on one switch and periodically turning on the other switch at a predetermined duty. Attenuation steps larger in number than switches can be obtained, the attenuation step width can be decreased, and the attenuation amount can be smoothly changed. While an increase in circuit scale is suppressed, the click sound can be reduced.

What is claimed is:

1. A variable resistance circuit comprising:
a resistor unit having a plurality of resistors series-connected between an input terminal and a predetermined potential terminal, and a switch group including a plurality of switches each having one end connected to a node between the input terminal and the resistor, a node between the resistors, or a node between the resistor and the predetermined potential terminal, and the other end connected to an output terminal; and
a switch control circuit which supplies a control signal to the switch group,
wherein an attenuation step is generated by supplying the control signal to a pair of adjacent switches included in the switch group so as to complementarily, periodically turning on/off the pair of switches at a duty of a/b (a and b are positive integers which satisfy a<b) for one switch and a duty of (b−a)/b for the other switch.

2. A circuit according to claim 1, further comprising resistors each connected between each switch included in the switch group, and a node between the input terminal and the resistor, a node between the resistors, or a node between the resistor and the predetermined potential terminal,
wherein the attenuation step is generated by supplying the control signal to the pair of adjacent switches included in the switch group so as to simultaneously turn on the pair of switches, or while keeping on one switch, turn on/off the other switch at the duty of a/b (a and b are positive integers which satisfy a<b).

3. A circuit according to claim 1, wherein a cycle in which said one switch and/or said other switch are turned on/off is smaller than a reciprocal of an audio frequency.

4. A circuit according to claim 3, wherein said switching control circuit comprises
a conversion circuit which receives at least two input data and converts the two input data into at least three output data, and
a decoder which receives the output data, generates the switching control signal, and outputs the switching control signal.

5. A circuit according to claim 4, wherein the resistor is connected to at least one portion between one end of a first switch and a node between the input terminal and one end of a first resistor, or between one end of a second switch and a node between the other end of the first resistor and the predetermined potential terminal.

6. A circuit according to claim 3, wherein the resistor is connected to at least one portion between one end of a first switch and a node between the input terminal and one end of a first resistor, or between one end of a second switch and a node between the other end of the first resistor and the predetermined potential terminal.

7. A circuit according to claim 1, wherein said switching control circuit comprises
a conversion circuit which receives at least two input data and converts the two input data into at least three output data, and
a decoder which receives the output data, generates the switching control signal, and outputs the switching control signal.

8. A circuit according to claim 1, wherein the resistor is connected to at least one portion between one end of a first switch and a node between the input terminal and one end of a first resistor, or between one end of a second switch and a node between the other end of the first resistor and the predetermined potential terminal.

9. A variable resistance circuit comprising:
a resistor unit having
first, second, . . . , (n-1)th (n is an integer of not less than 3) resistors which are series-connected between an input terminal and a predetermined potential terminal, and
first, second, . . . , nth switches each having one end connected to a node between the input terminal and one end of the first resistor, a node between the other end of the first resistor and one end of the second resistor, . . . , a node between the other end of the (n-2)th resistor and one end of the (n-1)th resistor, or a node between the other end of the (n-1)th resistor and the predetermined potential terminal, and the other end connected to an output terminal; and
a switching control circuit which generates a switching control signal for controlling ON/OFF states of the first, second, . . . , nth switches and supplies the switching control signal to the first, second, . . . , nth switches,
wherein in addition to n attenuation steps obtained by turning on any one of the first, second, . . . , (n-1)th switches, said switching control circuit generates m (m is a positive integer) additional attenuation steps by supplying, to the first, second, . . . , and nth switches, the switching control signal for complementarily, periodically turning on/off one switch at a duty of a/b (a and b are positive integers which satisfy a<b) and the other switch at a duty of (b−a)/b out of each of pairs of the first and second adjacent switches, the second and third adjacent switches, . . . , the (n-1)th and nth adjacent switches, and obtaining an attenuation amount calculated by internally dividing an attenuation amount x upon turning on only said one switch and an attenuation amount y upon turning on only said other switch at a:(b−a).

10. A circuit according to claim 9, wherein a cycle in which said one switch and/or said other switch are turned on/off is smaller than a reciprocal of an audio frequency.

11. A circuit according to claim 10, wherein said switching control circuit comprises
a conversion circuit which receives at least n input data and converts the at least n input data into at least n+m output data, and
a decoder which receives the output data, generates the switching control signal, and outputs the switching control signal.

12. A circuit according to claim 11, wherein the resistor is connected to at least one portion between one end of the first switch and a node between the input terminal and one end of the first resistor, between one end of the second switch and a node between the other end of the first resistor and one end of the second resistor, . . . , between one end of the (n-1)th switch and a node between the other end of the (n-2)th resistor and one end of the (n-1)th resistor, or between one end of the nth switch and a node between the other end of the (n-1)th resistor and the predetermined potential terminal.

13. A circuit according to claim 10, wherein the resistor is connected to at least one portion between one end of the first switch and a node between the input terminal and one end of the first resistor, between one end of the second switch and a node between the other end of the first resistor and one end of the second resistor, . . . , between one end of the (n-1)th switch and a node between the other end of the (n-2)th resistor and one end of the (n-1)th resistor, or between one end of the nth switch and a node between the other end of the (n-1)th resistor and the predetermined potential terminal.

14. A circuit according to claim 9, wherein said switching control circuit comprises
a conversion circuit which receives at least n input data and converts the at least n input data into at least n+m output data, and
a decoder which receives the output data, generates the switching control signal, and outputs the switching control signal.

15. A circuit according to claim 14, wherein the resistor is connected to at least one portion between one end of the first switch and a node between the input terminal and one end of the first resistor, between one end of the second switch and a node between the other end of the first resistor and one end of the second resistor, . . . , between one end of the (n-1)th switch and a node between the other end of the (n-2)th resistor and one end of the (n-1)th resistor, or between one end of the nth switch and a node between the other end of the (n-1)th resistor and the predetermined potential terminal.

16. A circuit according to claim 9, wherein the resistor is connected to at least one portion between one end of the first switch and a node between the input terminal and one end of the first resistor, between one end of the second switch and a node between the other end of the first resistor and one end of the second resistor, . . . , between one end of the (n-1)th switch and a node between the other end of the (n-2)th resistor and one end of the (n-1)th resistor, or between one end of the nth switch and a node between the other end of the (n-1)th resistor and the predetermined potential terminal.

17. A variable resistance circuit comprising:
a resistor unit having
1ath, 2ath, . . . , (n-1)ath resistors which are series-connected between an input terminal and a predetermined potential terminal,
a 1bth resistor having one end connected to a node between the input terminal and one end of the 1ath resistor, a 2bth resistor having one end connected to a node between the other end of the 1ath resistor and one end of the 2ath resistor, . . . , a kbth resistor having one end connected to the other end of the (k−1)ath (k is a positive integer which satisfies k<n-1) resistor and one end of the ka resistor, and
first, second, . . . , nth switches each having one end connected to the other end of the 1bth resistor, the other end of the 2bth resistor, . . . , the other end of the kbth resistor, a node between the other end of the kath resistor and one end of the (k+1)ath resistor, . . . , or a node between the other end of the (n-1)ath resistor and the predetermined potential terminal, and the other end connected to an output terminal; and
a switching control circuit which generates a switching control signal for controlling ON/OFF states of the first, second, . . . , nth switches and supplies the switching control signal to the first, second, . . . , nth switches,
wherein letting x be an attenuation amount upon turning on only one switch and y be an attenuation amount upon turning on only the other switch out of each of pairs of the first and second adjacent switches, the second and third adjacent switches, . . . , the (k−1)th and kth adjacent switches, said switching control circuit supplies the switching control signal to the first, second, . . . , nth switches so as to simultaneously turn on said one switch and said other switch, while turning on said one switch, periodically turn on/off said other switch at a duty of a/b, or periodically turn on/off said one switch at a duty of a/b and turn on said other switch in order to obtain an intermediate attenuation amount between x and y,
letting x be the attenuation amount upon turning on only said one switch and y be the attenuation amount upon turning on only said other switch, resistance values of the 1bth, 2bth, . . . , kbth resistors are so set as to adjust the attenuation amount to (x+y)/2 when said one switch and said other switch are simultaneously turned on, and
an attenuation amount calculated by internally dividing the attenuation amount x and an attenuation amount (x+y)/2 at a:(b−a) is generated by turning on said one switch and periodically turning on/off said other switch at a duty of a/b, and an attenuation amount calculated by internally dividing the attenuation amount (x+y)/2 and the attenuation amount y at (b−a):a is generated by periodically turning on/off said one switch at the duty of a/b and turning on said other switch.

18. A circuit according to claim 17, wherein a cycle in which said one switch and/or said other switch are turned on/off is smaller than a reciprocal of an audio frequency.

19. A circuit according to claim 18, wherein said switching control circuit comprises
a conversion circuit which receives at least n input data and converts the at least n input data into at least n+m(m is a positive integer) output data, and
a decoder which receives the output data, generates the switching control signal, and outputs the switching control signal.
